(19) United States
(12) Patent Application Publication
(10) Pub. No.: US 2005/0008787 A1
(43) Pub. Date: Jan. 13, 2005

(54) Applicator and coating assembly for applying coatings and method of using the same

(76) Inventors: James William O'Neil, Chadds Ford, PA (US); Jay Alan Kaiser, Wyndmoor, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/861,671

(22) Filed: Jun. 4, 2004

Related U.S. Application Data
(60) Provisional application No. 60/485,528, filed on Jul. 7, 2003.

(51) Int. Cl. B05C 11/02

(52) U.S. Cl. 427/428.01; 118/110

(57) ABSTRACT

The present invention relates to various embodiments of an applicator and a coating assembly for applying coatings to substrates as well as a method for using the present invention in the application of many types of coatings. The applicator has an internal length that is less than its external length, thereby resulting in the center point at least one end surface being recessed into the interior of the applicator.

### FIELD OF THE INVENTION

The present invention relates to an applicator and a coating assembly for applying coatings to substrates and a method of using the same. The applicator has an internal length that is less than its external length, thereby resulting in the center point of at least one end surface being recessed into the interior of the applicator.

### BACKGROUND

Various methods of applying a coating to a surface of a substrate are well known in the art such as, for example, spray coating and roller coating. Spray coatings are often used because they have a smooth and uniform appearance. However, one disadvantage of using a spray coating is the time and expense required for the masking process (the preparation of the substrate to have the coating applied). In most cases, the roller application would not require a masking process.

Standard rollers have also been utilized in the application of coatings, wherein these rollers have end surfaces that are “domed” (i.e., convex) or straight-edged. However, a disadvantage of using rollers of these types is that they deposit coatings having tracks on the surface resulting from the edges of the rollers. The tracks are problematic because they result in a poorer coating appearance, and in automotive coatings, they can result in an increase in preparation times due to extended sanding times.

There remains a need in the industry for an application method that results in a coating where tracks resulting from the edge of the roller are not apparent, and having a more uniform thickness and appearance, more closely approximating the coatings provided by spray gun methods.

### SUMMARY OF THE INVENTION

The present invention relates to a coating applicator, as well as a coating assembly comprising an applicator comprising a substantially cylindrical applicator body having an outer surface; a first end and an opposing second end; an external length; and an internal length that is less than said external length; wherein said applicator is capable of accepting a support axle. The surface of at least one of the first or second ends is concave, conical, pyramidal or some other shaped cavity.

The coating assembly comprises the above-described applicator, a support axle extending into the applicator; and a handle connected to the support axle, and optionally, the support axle may comprise a means for preventing the applicator from contacting the shaft of the handle selected from the group consisting of wings, a collar or an expanded axle portion.

The present invention further relates to process for applying a coating to a substrate comprising:
(a) providing a coating assembly comprising a substantially cylindrical applicator comprising an outer surface; a first end and an opposing second end; an external length; and an internal length that is less than said external length; a support axle extending into the applicator; and a handle connected to the support axle, wherein the applicator has a coating substance thereon; and
(b) depositing the coating by rolling the coating assembly over a surface of the substrate.

### BRIEF DESCRIPTION OF THE DRAWINGS

FIG. 1 shows an embodiment of the applicator according to the present invention.

FIG. 2 shows an alternative embodiment of the applicator according to the present invention.

FIG. 3 shows an alternative embodiment of the applicator according to the present invention.

FIG. 4 shows an embodiment of the coating assembly according to the present invention.

FIG. 5 shows an embodiment of the support axle of the coating assembly according to the present invention.

FIG. 6 shows an embodiment of the support axle of the coating assembly according to the present invention.

FIG. 7 shows an alternative embodiment of the support axle of the coating assembly according to the present invention.

FIG. 8 shows a typical coating assembly.

FIG. 9 shows a typical coating assembly.

FIG. 10 shows an embodiment of the coating assembly according to the present invention.

FIG. 11 shows an embodiment of the coating assembly according to the present invention.

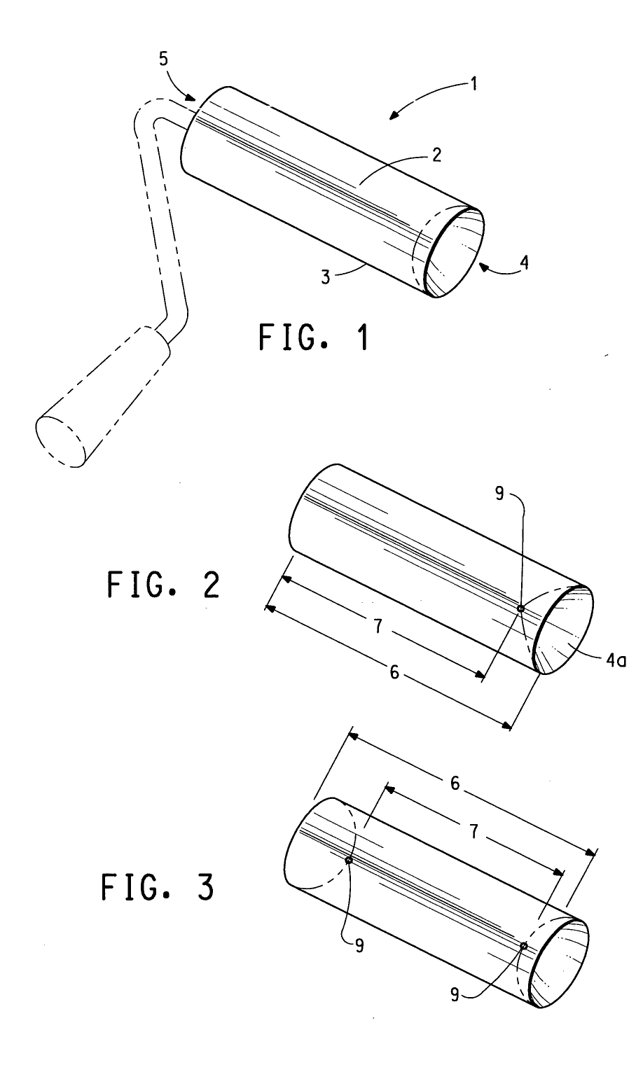

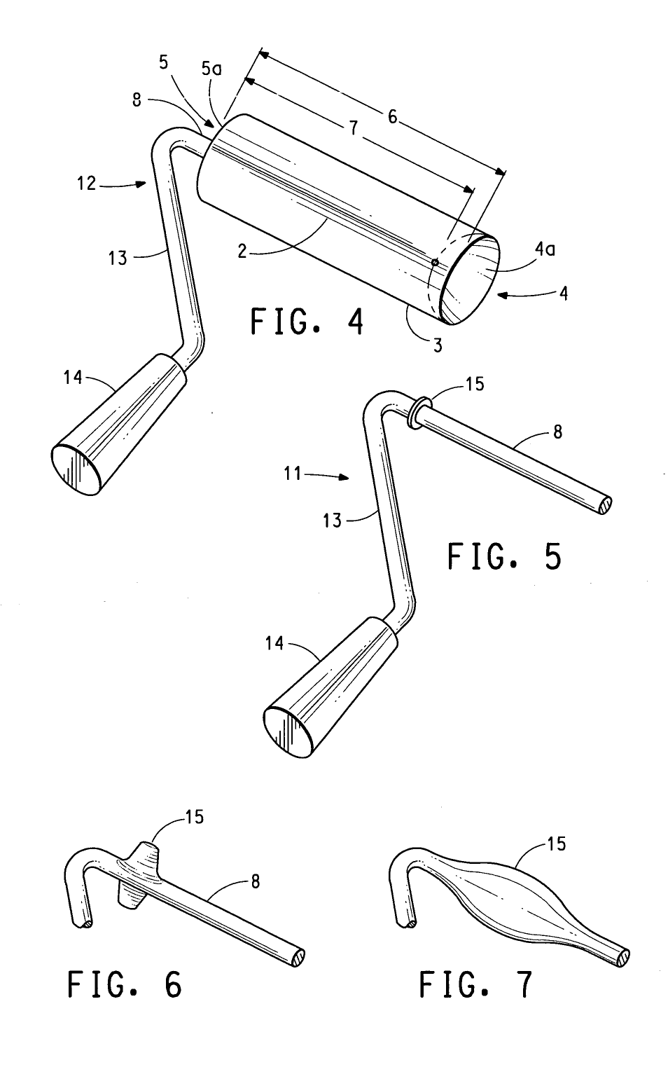

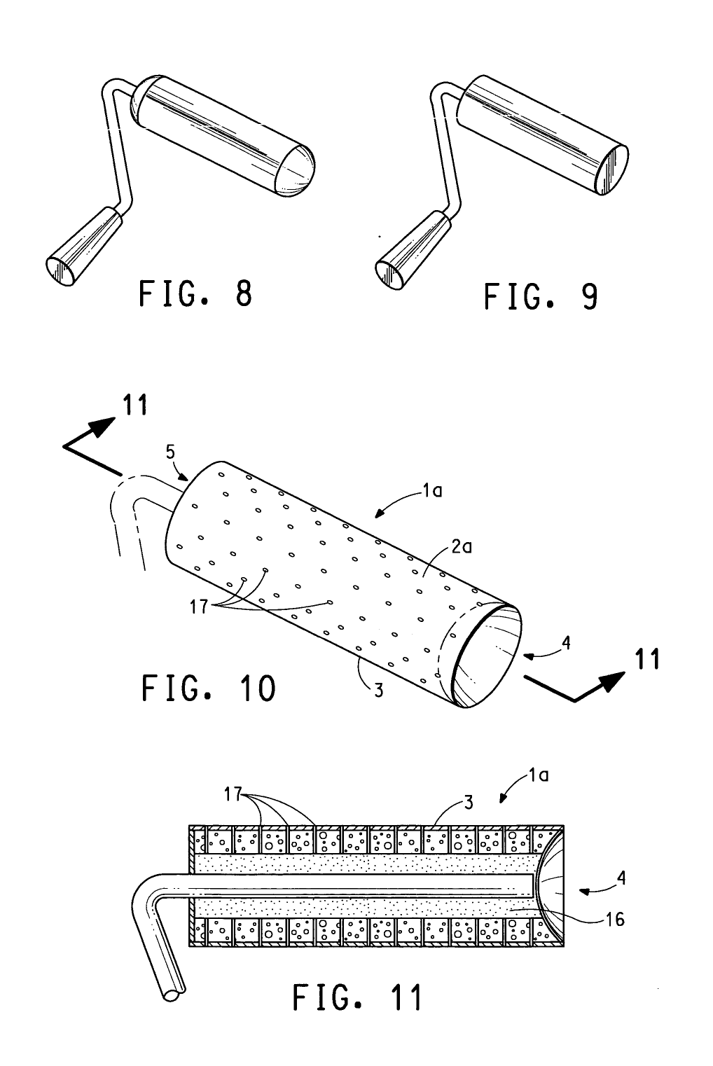

### DETAILED DESCRIPTION

The present invention is intended for use in conjunction with many types of coatings such as paints or other types of pigmented coatings for use in the residential, industrial or commercial sectors, stains (i.e., those used for wood floors, decking, etc.), automotive coatings (i.e. clear coats and primers or undercoats), architectural coatings, commercial finishes, any industrial or residential coatings or other coatings applied to any substrate, for example, automotive bodies and parts thereof, walls, floors, ceilings, industrial structures, ship's hulls, home use, aircraft bodies and the like. Most preferably, the present invention is used in the application of refinishing coatings in the automotive industry for coating automotive bodies and parts thereof.

The present invention relates to various embodiments of an applicator and a coating assembly for applying coatings to substrates as well as a method for using the present invention.

Without being bound by theory, it is believed that when a standard roller is used and the coating is applied to the entirety of the roller's surfaces, residual coating material that is not in contact with a surface of the substrate runs down to the first point of contact between the standard roller and the substrate surface, thereby depositing superfluous amounts of coating material on the substrate's surface. The resultant effect is the appearance of thick tracks on the surface of the applied coating, and thus, the coating lacks a uniform thickness and appearance.

As used herein, “external length” shall mean the overall length of the applicator as measured from the outermost edges of the applicator.

As used herein, “internal length” shall mean the measured distance between the center point of at least one end surface that is recessed into the interior of the applicator's body and the edge of the applicator. The internal length may also be the measured distance between the center points of both the first end and opposing second end, where both center points are recessed into the interior of the applicator, although each center point may be recessed to a different depth. In each instance, this internal length will be less than the external length.

As used herein, “smooth or uniform appearance” shall mean that the coating applied via the applicator, coating assembly and process of the present invention does not exhibit tracks on its surface.

The present invention generally relates to a coating applicator (1) having a substantially cylindrical body (2) of sufficient rigidity to allow the applicator to maintain its shape during normal usage, wherein the applicator comprises an outer surface (3); a first end (4); an opposing second end (5); an external length (6); and an internal length (7) that is less than said external length; wherein said applicator is capable of accepting a support axle (8).

In general, the applicator (1) can be of any size, such that it may be utilized in a wide variety of applications as noted above, however the applicator preferably has an external length (6) up to about 30 inches, more preferably ranging from about 2 inches to about 24 inches, most preferably ranging from about 2.125 inches to about 4.125 inches. The internal length (7) may be any length that is less than the external length, however the internal length preferably ranges from about 1 inch to about 29 inches more preferably ranging from about 1.25 inches to about 23 inches, and most preferably ranging from about 1.5 inches to about 3.625 inches.

Moreover, the external (6) and internal lengths (7) need not be in a particular ratio, wherein the ratio of external to internal length may vary widely, but is preferably from about 2:1.95 to about 3:1, more preferably from about 2:1.9 to about 2.5:1, even more preferably from about 2:1.85 to about 2:1 and most preferably the ratio is 1.14:1

In addition, the diameter of the end surfaces (both the first (4) and second ends (5)) is typically at least 0.5 inches, preferably 3 inches, most preferably 1.375 inches.

The ratio of the external (6) or internal length (7) to an end surface diameter need not be in any particular ratio, wherein the diameter of either the first end (4), opposing second end (5) or both may be greater than or less than the internal (7) and/or external (6) lengths. Preferably, however, the ratio of the diameters of the end surfaces to the external length ranges from about 1:1 to about 1:30, more preferably from about 1:1.5 to about 1:24, even more preferably from about 1:2 to about 1:12 and most preferably the ratio is 1.375:4.125.

Preferably, the first end (4) and opposing second end (5) of the applicator (1) are generally of the same diameter, however, when the application requires, their diameters may be varied, such that the diameter of the first end may be either greater than or less than the diameter of the opposing second end.

The applicator body (2) may be comprised of a wide variety of materials including, but not limited to a foam, a fabric, cardboard, plastic (i.e., flexible or hard), rubber, metals or the like. Preferably, when a fabric is utilized with the present invention, the fabric forms a conforming sleeve over a foam or rubbery surface. Fabrics typically give, by design, a patterned and rougher, textured surface appearance.

Suitable foams include, but are not limited to, polyurethane foam, polyester foam and polyether foam. For example, a preferred foam is a flexible polyester-based polyurethane foam (i.e., a polyester foam available from Worktools International, Inc., Largo Fla., manufactured by FIA Farbwerkzeuge Gmbh).

In general, the foam for use in the present invention may be one having a wide range of densities and porosities. Typically, the foam has a density ranging from about 5 Kg/m³ to about 200 Kg/m³, preferably from about 20 Kg/m³ to about 100 Kg/m³, more preferably from about 30 Kg/m³ to about 80 Kg/m³, and most preferably from about 45 Kg/m³ to about 55 Kg/m³. With respect to porosity, the foam may have a porosity ranging from about 0 cells/cm to about 60 cells/cm, preferably from about 10 cells/cm to about 50 cells/cm, more preferably from about 20 cells/cm to about 40 cells/cm, and most preferably from about 30 cells/cm to about 33 cells/cm.

Suitable fabrics for use with the present invention include, but are not limited to nylon, polyethylene, polyester yarn, velour, polyamide yarn, lambskin, lamb's wool, mohair, and blends thereof; as well as rubber (i.e., natural rubber, silicon and elastomers etc.) and sponge-like materials (i.e., natural or synthetic sponges).

The outer surface (3) of the applicator (1) may be either the same or different than the material comprising the applicator. For example, the outer surface (3) may comprise the same foam as that used for the body (2) of the applicator (1). Alternatively, the outer surface may be covered by foam that is different than the foam utilized for the applicator body. When a fabric is utilized, generally, the fabric will substantially encase the applicator (i.e., a conforming sleeve) and conform to its shape, wherein the fabrics are reinforced by a rigid applicator, such that the advantageous properties conferred by the design of the applicator will not be diminished.

In general, at least one of the first end surface (4a) or opposing second end surface (5a) of the applicator (1) has a recessed center point (9) (wherein the measured distance between the end center points is the internal length (7)), thereby forming a cavity that is substantially concave, conical, pyramidal, cubic and the like. Preferably, both ends have the same configuration, although ends having different configurations may be utilized.

Preferably, the first end (4) of the applicator (1) is closed, such that the support axle (8) does not penetrate through the first end surface (4a) where it is exposed, although such a design is contemplated by the present invention.

An alternative embodiment of the present invention includes the applicator (1) having a hollow interior cavity, wherein it is capable of being used in conjunction with conventional roller frames or cages, which are well known in the art. Preferably, these embodiments have flexible edges in accordance with other embodiments of the present invention.

Another alternative embodiment of the applicator (1a) provides for the body (2a) of it to be hollow, thereby acting as an internal reservoir (16) for containing and/or dispensing of the coating substance, in such an instance, the applicator may have at least one slot, slit, hole or other type of aperture (17) that would allow for the passage of the coating substance, wherein the internal reservoir and the outer surface (3) are in fluid communication with one another so that the coating substance may be applied to a substrate. The tubular core (10) (as described below) may act as the reservoir or there may be another chamber between the tubular core and the applicator's outer surface (3) where the coating substance may be stored. Furthermore, the internal reservoir may be fluidly connected (i.e., using a tubing) to a coating substance source, such as a tank or can, wherein the coating substance may be in substantially continuous supply so that the user does not need to interrupt the coating application process in order to obtain more of the coating substance.

The applicator (1) is also capable of accepting a support axle (8) (that is ultimately connected to a handle (11)), about which the applicator rotates. Typically, the opposing second end (5) is the entrance point where the support axle may be inserted into the interior of the applicator. It is also contemplated by the present invention that both the first (4) and second ends (5) are capable of receiving the support axle.

The applicator (1) is capable of accepting the support axle (8) into its interior, wherein the applicator may generally further comprise a tubular core (10) into which the support axle extends. This tubular core (10) allows for the applicator to remain in place on the support axle (8), while the support axle also allows for the applicator to rotate about its longitudinal axis in the application of a coating. The tubular core (10) may be comprised of a hard or flexible plastic, a cardboard material, metal, wood or the like.

The present invention also contemplates a coating assembly (12) comprising the applicator (1) described herein and a handle (11). Any handles known within the art can be used with the present invention. A typical handle comprises a shaft (13) connected to the support axle (8) and a means for grasping the shaft (14), as shown in the Figures.

The support axle (8) for use with the present invention may further comprise a means for preventing the applicator from contacting or rubbing the shaft (13) of the handle (11), for example, a wing, a collar, an expanded portion of the support axle, and the like. The contacting or rubbing of the applicator against the shaft of the handle could compromise the performance of the applicator. Moreover, the support axle (8) may be flexible, such that, it is capable of conforming to the shape of the substrate's surface to which the coating is being applied.

One embodiment of the coating assembly (12) relates to the use of multiple applicators of the present invention, wherein the support axle may have more than one applicator along its axis. Such a configuration would be beneficial when utilized with a flexible support axle, and thus, the multiple applicators may aid in the support angle's conforming to the shape of the substrate's surface

The present invention further contemplates a process for applying a coating to a substrate comprising:
(a) providing a coating assembly according to the present invention, having a coating substance thereon; and
(b) depositing a coating by rolling the coating assembly over a surface of a substrate.

The coating substances for use with the present invention may be any conventionally known within the art for use in coating applications such as those described above and may be applied according to those conventional methods known to those skilled in the art.

The application of a coating substance using the present invention provides a coating having a more uniform thickness and smooth appearance when compared to the results found using standard rollers, as shown in the Examples and Tables. While not wishing to be bound by theory, it is believed that there is a feathering effect at the edges of the coating, where the coating thickness decreases gradually such that there are no visible tracks in the surface of the coating, to allow better blending of the surfaces in a refinishing process.

Typically, standard rollers result in the applied coating having greater variation in its thickness as well as a lack of feathering such that the thickness of the applied coating substantially continues to the outermost edge of the coating, which is believed to result in the appearance of visible tracks in the surface of the coating. Thus, the coatings applied using the present invention have a better visual appearance than those applied using standard rollers. With specific reference to the refinishing aspect of the automotive industry, the applied coatings that result from the use of the present invention require less sanding due to the lack of the tracks.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usage and conditions.

Rollers used in the Examples:

Dome roller: a 4″ medium build foam roller having rounded ends (available from Worktools International, Inc., Largo Fla.).

Concave roller: These medium build foam rollers had a closed first end, the surface of which had a recessed concave configuration. The applicator had an external length of about 4.125″, an internal length of about 3.625″, a diameter of 1.375″, and a density of 45 Kg/cm³.

In the Examples, the coating substance was applied to the rollers using standard trays known in the art (a plastic tray approximately 11 inches long, 2½ inches deep, lined with aluminum foil), wherein the coating substance was poured into the tray and the roller was saturated with the coating substance. Subsequently, some excess coating substance was “rolled-out” in the upper portion of the tray.

The application of the coating substance was performed by rolling the coating onto the surface of the substrate in a V-shaped pattern, covering the surface of the substrate with a coating layer generally having the same width as the applicator in accordance with ASTM D 3276-00. The applicator handle was on the right side of the applicator and application of the coating substance was lengthwise, from the bottom to the top of the aluminum panel.

Metal sheets were used as the substrate in these Examples, wherein a coating substance was applied to its surface using either a roller according to the present invention or a dome roller as known in the art, both of which had the same density, porosity, diameter and holder type. The metal substrates were aluminum sheets (approximately 12 inches by 18 inches), prepared by sanding the surface with a 180 grit sandpaper, and then cleaned using Final Klean 3901S solvent cleaner (available from E.I. du Pont de Nemours and Company, Wilmington, Del.).

The panels were coated according to several different coating substance loadings on the applicators, namely light, medium and/or heavy coatings. A light coat means minimum loading on the applicator, and where application speed is normal and application pressure is normal. A medium coat is one having more paint on the roller, slower application speed with more pressure exerted during application. The heavy coat represents a heavily loaded roller with very slow application speed and even greater pressure exerted during rolling. The coatings may also be defined in terms of the applicator's appearance, wherein the applicator looks “wetter” as the coating loading moves from light to heavy.

Coating thicknesses were evaluated in accordance with ASTM B-499-96, however alternatively, may be evaluated in accordance with D 4138-94 (1999). Coating appearance may be evaluated as per D 3964-80 (reapproved 1998). The coating thickness measurements were taken at the positions shown in the tables such that the location of the thickness value is the position at which the measurement was taken. Coating thickness was measured using an electronic thickness gauge (i.e., using an ETG-N from ETG^{r}), which provides film measurements over an aluminum substrate.

For each panel, average thickness values and variation values were calculated, as well as the differences within each range. The “average thickness” of the coating was calculated using the measured values at left, center and right positions (each having the same latitude) on the coated portion of the substrate. The “variation” values were calculated to show the difference between the thickest and thinnest portions of the coating from those same left, center and right positions described above. The “difference” values were calculated for both the average thickness and variation values. The average thickness difference was calculated to show the difference between the thickest and thinnest portions of the coating from the top of the panel to the bottom of the panel. The variation difference was calculated to show the variation of the coating thickness from the top of the panel to the bottom of the panel. Thus, the “difference” values show the coating's uniformity across the entire coated area.

### Example 1

In this Example 1, Spies 4080 primer surfacer was first applied to the surface of the substrate (an optional step). A single coat of a 4004S /FGP30568 combination (a mixture of 1 part FGP30568 activator (a ketimine based crosslinking activator) to 5 parts 4004S Ultraproductive Primer (a polyacrylic acetoacetonate) that is crosslinked with the activator (both available from E.I. du Pont de Nemours and Company, Wilmington, Del.)) was applied as a light, medium and heavy coating. The thickness of each coating was measured and the results are shown below in Tables 1-3.

TABLE 1
Application of a light coating

| Concave Roller | | | | | Dome Roller | | | | |
|---|---|---|---|---|---|---|---|---|---|
| TOP OF PANEL | | | Avg. | Var. | TOP OF PANEL | | | Avg. | Var. |
| 0.7 | 0.5 | 0.2 | 0.47 | 0.50 | 0.4 | 0.4 | 1.0 | 0.60 | 0.60 |
| 0.6 | 0.5 | 0.4 | 0.50 | 0.20 | 0.4 | 0.4 | 1.0 | 0.60 | 0.60 |
| 0.7 | 0.5 | 0.3 | 0.50 | 0.40 | 0.5 | 0.5 | 0.2 | 0.40 | 0.30 |
| 0.4 | 0.4 | 0.4 | 0.40 | 0.00 | 0.7 | 0.6 | 0.3 | 0.53 | 0.40 |
| 0.6 | 0.5 | 0.5 | 0.53 | 0.10 | 0.5 | 0.6 | 0.6 | 0.57 | 0.10 |

| | | | | | |
|---|---|---|---|---|---|
| Difference = | 0.13 | 0.50 | Difference = | 0.20 | 0.50 |

The domed applicator resulted in the coating having a ridge on the right side. The track was discontinuous, wherein it became narrower or disappeared throughout the length of the applied coating. The ridge varied in thickness (width), such that in its narrowest regions its width was difficult to measure. The left side of the applied coating using the dome roller did not exhibit any apparent tracks. The track in the dome roller applied coating was able to be manually felt using one's finger to assess the coating thickness as the finger was drawn from the uncoated metal sheet across the coated portions on the metal sheet. The “rise” was felt at the thicker parts of the edge of the coating. The track visible on the right side of the applied coating results in the coating having a poorer visual appearance than the coating applied using the present invention.

The coating applied utilizing the concave roller embodiment of the present invention did not result in any visible tracks on either side of the coating and had a smoother feathered appearance at both edges when tactilely assessed, such that one does not feel a thick edge.

TABLE 2
Application of a medium coating

| Concave Roller | | | | | Dome Roller | | | | |
|---|---|---|---|---|---|---|---|---|---|
| TOP OF PANEL | | | Avg. | Var. | TOP OF PANEL | | | Avg. | Var. |
| 0.6 | 0.7 | 0.4 | 0.57 | 0.30 | 0.6 | 0.6 | 0.5 | 0.57 | 0.10 |
| 0.7 | 0.6 | 0.6 | 0.63 | 0.10 | 0.6 | 0.5 | 1.4 | 0.83 | 0.90 |
| 0.7 | 0.5 | 0.4 | 0.53 | 0.30 | 0.4 | 0.6 | 2.2 | 1.07 | 1.80 |
| 0.6 | 0.8 | 0.3 | 0.57 | 0.50 | 0.5 | 0.8 | 0.8 | 0.70 | 0.30 |
| 0.5 | 0.7 | 0.4 | 0.53 | 0.30 | 0.6 | 0.5 | 0.5 | 0.53 | 0.10 |

| | | | | | |
|---|---|---|---|---|---|
| Difference = | 0.10 | 0.40 | Difference = | 0.54 | 1.70 |

The domed applicator resulted in the coating having a ridge on both sides of the coating. The track on the right side was more pronounced and more continuous than in the application of the lighter coating, wherein portions of the tracks were wide and very visible, as well as easily felt when tactilely assessed. The track visible on the left side of the coating resembled that from the lighter applied coating (its right side) as described above, wherein it was discontinuous along portions of the coating, but did exhibit some wider portions that were visible.

The coating applied utilizing the concave roller embodiment of the present invention did not result in any visible tracks on either side of the coating, but had slightly better coverage than the light application, and had a smoother feathered appearance at both edges.

TABLE 3
Application of a heavy coating

| Concave Roller | | | | | Dome Roller | | | | |
|---|---|---|---|---|---|---|---|---|---|
| TOP OF PANEL | | | Avg. | Var. | TOP OF PANEL | | | Avg. | Var. |
| 0.7 | 1.1 | 0.8 | 0.87 | 0.40 | 0.8 | 0.9 | 1.2 | 0.97 | 0.40 |
| 0.8 | 1.1 | 0.8 | 0.90 | 0.30 | 0.9 | 0.9 | 1.8 | 1.20 | 0.90 |
| 0.8 | 1.1 | 0.7 | 0.87 | 0.40 | 0.7 | 0.8 | 0.7 | 0.73 | 0.10 |
| 0.6 | 1.0 | 0.8 | 0.80 | 0.40 | 1.0 | 0.8 | 1.1 | 0.97 | 0.30 |
| 0.9 | 0.8 | 0.8 | 0.90 | 0.10 | 2.3 | 0.7 | 0.7 | 1.23 | 1.60 |

| | | | | | |
|---|---|---|---|---|---|
| Difference = | 0.10 | 0.30 | Difference = | 0.50 | 1.50 |

The domed applicator resulted in the coating having a ridge on both sides of the applied coating, however the track on the right side was slightly thicker than that observed on the left side. Both tracks were readily felt when tactilely assessed, and thus the coating applied using the dome roller had a poorer visual appearance than the coating applied using the present invention.

The coating applied utilizing the concave roller embodiment of the present invention did not result in any visible tracks on either side of the coating. The portion of the coating on the handle side had a smoother appearance than the opposing side. While the paint was heavily loaded onto the substrate and may be considered flooded, thereby requiring further rolling to result in better smoothness, no visible tracks were apparent in the coating.

### Example 2

In this Example, one coat of IMRON 1.5 PR, a waterborne polyurethane copolymer primer at heavy film builds was applied to the aluminum panel. The fabric roller was a ⅜inch nap roller (available from Bestt Liebco); smooth surface; 4″ length; different applicator handle; 1.5″ opening for applicator. The fabric roller “slid” across the surface of the substrate and did not roll easily.

TABLE 4
Application of a heavy coating

| Concave Roller | | | | | Dome Roller | | | | |
|---|---|---|---|---|---|---|---|---|---|
| TOP OF PANEL | | | Avg. | Var. | TOP OF PANEL | | | Avg. | Var. |
| 0.3 | 0.4 | 0.2 | 0.30 | 0.20 | 0.5 | 0.6 | 0.5 | 0.53 | 0.10 |
| 0.4 | 0.2 | 0.2 | 0.27 | 0.20 | 2.1 | 0.4 | 0.9 | 01.13 | 1.70 |
| 0.2 | 0.2 | 0.2 | 0.20 | 0.00 | 2.3 | 0.8 | 0.4 | 1.17 | 1.90 |
| 0.3 | 0.2 | 0.1 | 0.20 | 0.20 | 2.5 | 0.6 | 0.8 | 1.30 | 1.90 |
| 0.2 | 0.2 | 0.2 | 0.20 | 0.00 | 3.1 | 0.4 | 0.4 | 1.30 | 2.70 |

| | | | | | |
|---|---|---|---|---|---|
| Difference = | 0.10 | 0.20 | Difference = | 0.67 | 2.60 |

TABLE 5
Application of a heavy coating

| Fabric Roller | | | | |
|---|---|---|---|---|
| TOP OF PANEL | | | Avg. | Var. |
| 0.3 | 0.7 | 0.9 | 0.63 | 0.60 |
| 0.1 | 0.3 | 1.5 | 0.63 | 1.40 |
| 0.6 | 0.5 | 0.4 | 0.50 | 0.20 |
| 0.3 | 0.5 | 0.6 | 0.47 | 0.30 |
| 0.1 | 0.2 | 0.2 | 0.17 | 0.10 |

| | | |
|---|---|---|
| Difference = | 0.46 | 1.30 |

The domed applicator resulted in the coating having a ridge on both sides of the applied coating, however the track on the side opposite the handle was much thicker and wider than that observed on the side having the handle, which exhibited a narrow, thinner track along the edge. Both tracks were readily felt when tactilely assessed, and thus the coating applied using the dome roller had a poorer visual appearance than the coating applied using the present invention.

The coating applied using the fabric roller exhibited a thick and wide edge at the handle-side edge, and a narrow and discontinuous edge track on the opposite side. Thinner applications using the fabric roller resulted in the same poor performance.

The coating applied utilizing the concave roller embodiment of the present invention did not result in any visible tracks on either side of the coating, while also providing a more uniform coating.

### Example 3

In this Example, one coat of Benjamin Moore interior white latex house paint at different film builds was applied on an aluminum panel. The fabric roller was a ⅜ inch nap roller (available from Bestt Liebco); smooth surface; 4″ length; different applicator handle; 1.5″ opening for applicator. The results are shown in Tables 6-7.

TABLE 6
Application of a single coating

| Concave | | | | | Dome | | | | |
|---|---|---|---|---|---|---|---|---|---|
| TOP OF PANEL | | | Avg. | Var. | TOP OF PANEL | | | Avg. | Var. |
| 0.1 | 0.3 | 0.7 | 0.37 | 0.60 | 0.5 | 0.3 | 0.2 | 0.30 | 0.30 |
| 0.1 | 0.3 | 0.4 | 0.27 | 0.30 | 0.1 | 0.3 | 0.2 | 0.23 | 0.20 |
| 0.1 | 0.4 | 0.7 | 0.40 | 0.60 | 0.3 | 0.4 | 0.5 | 0.40 | 0.20 |
| 0.1 | 0.5 | 0.9 | 0.50 | 0.80 | 0.2 | 0.4 | 0.3 | 0.30 | 0.20 |
| 0.3 | 0.4 | 0.8 | 0.50 | 0.50 | 0.3 | 0.4 | 0.7 | 0.47 | 0.40 |

| | | | | | |
|---|---|---|---|---|---|
| Difference = | 0.23 | 0.50 | Difference = | 0.24 | 0.20 |

TABLE 7
Application of a single coat

| Fabric | | | | |
|---|---|---|---|---|
| TOP OF PANEL | | | Average | Variation |
| 0.4 | 0.5 | 0.7 | 0.53 | 0.30 |
| 0.2 | 0.3 | 0.4 | 0.30 | 0.20 |
| 0.3 | 0.3 | 0.8 | 0.47 | 0.50 |
| 0.8 | 0.6 | 0.7 | 0.70 | 0.20 |
| 0.5 | 0.8 | 1.0 | 0.77 | 0.50 |

| | | |
|---|---|---|
| Difference = | 0.47 | 0.30 |

Applications using the domed applicator resulted in the coating having a narrow track on the handle side of the applied coating. The track was discontinuous but visually apparent. Thus the coating applied using the dome roller had a poorer visual appearance than the coating applied using the present invention.

The coating applied using the fabric roller exhibited a narrow track, that was fairly continuous, on the handle side of the applied coating and a small narrow track on the opposite side.

The coating applied utilizing the concave roller embodiment of the present invention was less uniform from side to side in this example, but did not result in any visible tracks on either side of the coating. One portion of the coating appeared flooded, but did not show any visible tracks.

### Example 4

This example deals with collision repair where two aluminum substrates were prepared by sanding the surface with a 180 grit sandpaper and then cleaned using Final Klean 3901S solvent cleaner (available from E.I. du Pont de Nemours and Company, Wilmington, Del.). Spies 4080 primer surfacer was first applied to the surface of the substrate (an optional step). One panel was coated using a commercial domed roller, and the other panel would be coated with a concave roller of the present invention. Three coats of primer were applied, with a flash time allowing the primer to surface dry in between coats. The primer coating substance was a mixture of 1 part FGP30568 activator (a ketimine based crosslinking activator) to 5 parts 4004S Ultraproductive Primer, a polyacrylic acetoacetonate based highly pigmented primer (both available from E.I. du Pont de Nemours and Company, Wilmington, Del.).

Three (3) roller coats were applied with a 6-minute flash in-between coatings to each panel. It was observed after each application, that the domed roller was giving tracks from the rollers edge. The tracks were not seen with the concave roller. After the coating cured (a time of more than 60 minutes allowed for curing (air drying) at room temperature), each substrate was sanded with a fine grit sand paper (i.e., P400 available from 3M) to obtain a smooth surface. The panel coated with the domed roller required more sanding time to remove the aesthetically unpleasing track marks. After sanding the panels to a smooth uniform appearance such that there were no tracks or texture, the surface of each panel was then cleaned with Final Klean 3901S solvent cleaner (available from E.I. du Pont de Nemours and Company, Wilmington, Del.), and subsequently topcoated with a standard topcoat material. Topcoat was DuPont ChromaBase basecoat and DuPont's 7900S clearcoat, which were applied per Dupont specification.

1. A coating applicator comprising:
a substantially cylindrical applicator comprising an outer surface; a first end and an opposing second end; an external length; and an internal length that is less than said external length; wherein said applicator is capable of accepting a support axle.

2. The applicator according to claim 1, wherein the applicator has a porosity ranging from about 0 cells/cm to about 60 cells/cm.

3. The applicator according to claim 1, wherein the applicator has a density ranging from about 5 Kg/m³ to about 200 Kg.m³.

4. The applicator according to claim 1, wherein the applicator is a foam.

5. The applicator according to claim 1, wherein the applicator is a flexible foam.

6. The applicator according to claim 4, wherein the foam is polyurethane, polyester or polyether.

7. The applicator according to claim 1, wherein the applicator further comprises a fabric covering the outer surface.

8. The applicator according to claim 7, wherein the fabric is nylon, polyethylene, polyester yarn, velour, polyamide yarn, lambskin, lamb's wool and blends thereof; rubber, synthetic sponges or natural sponges.

9. The applicator according to claim 1, wherein the applicator has an external length to internal length ratio ranging from about 2:1.95 to about 3:1.

10. The applicator according to claim 1, wherein the applicator has an external length to end surface diameter ratio ranging from about 1:1 to about 30:1.

11. The applicator according to claim 1, wherein the applicator has a closed first end.

12. The applicator according to claim 1, wherein a surface of at least one of the first or second ends is concave, conical or pyramidal.

13. The applicator according to claim 1, wherein the applicator is hollow.

14. The applicator according to claim 13, wherein the hollow portion of the applicator acts as an internal reservoir containing a coating substance.

15. The applicator according to claim 14, wherein the applicator further comprises at least one aperture in fluid communication with the internal reservoir and the outer surface.

16. A coating assembly comprising:
the applicator according to claim 1;
a support axle extending into the applicator; and
a handle connected to the support axle.

17. The coating assembly according to claim 16, wherein the support axle comprises a means for preventing the applicator from contacting the shaft of the handle selected from the group consisting of wings, a collar or an expanded axle portion.

18. The coating assembly according to claim 16, wherein the support axle is flexible.

19. A process for applying a coating to a substrate comprising:
(a) providing a coating assembly comprising a substantially cylindrical applicator comprising an outer surface; a first end and an opposing second end; an external length; and an internal length that is less than said external length; a support axle extending into the applicator; and a handle connected to the support axle, wherein the applicator has a coating substance thereon; and
(b) depositing the coating by rolling the coating assembly over a surface of the substrate.

20. The process according to claim 19, wherein the applicator has a porosity ranging from about 0 cells/cm to about 60 cells/cm.

21. The process according to claim 19, wherein the applicator has a density ranging from about 5 Kg/m³ to about 200 Kg.m³.

22. The process according to claim 19, wherein the applicator is a foam.

23. The process according to claim 19, wherein the applicator is a flexible foam.

24. The process according to claim 22, wherein the foam is polyurethane; polyester or polyether.

25. The process according to claim 19, wherein the applicator further comprises a fabric covering the outer surface.

26. The process according to claim 25, wherein the fabric is nylon, polyethylene, polyester yarn, velour, polyamide yarn, lambskin, lamb's wool and blends thereof; rubber, synthetic sponges or natural sponges.

27. The process according to claim 19, wherein the applicator has an external length to internal length ratio ranging from about 2:1.95 to about 3:1.

28. The process according to claim 19, wherein the applicator has an external length to end surface diameter ratio ranging from about 1:1 to about 30:1.

29. The process according to claim 19, wherein the applicator has a closed first end.

30. The process according to claim 19, wherein the applicator is hollow.

31. The process according to claim 30, wherein the hollow portion of the applicator acts as an internal reservoir containing a coating substance.

32. The process according to claim 31, wherein the applicator further comprises at least one aperture in fluid communication with the internal reservoir and the outer surface.

33. The process according to claim 19, wherein a surface of at least one of the first or second ends is concave, conical or pyramidal.

34. The process according to claim 19, wherein the support axle comprises a means for preventing the applicator from contacting the shaft of the handle selected from the group consisting of wings, a collar or an expanded axle portion.

35. The process according to claim 19, wherein the coating is a pigmented coatings, a stain, a clear coat, a primers, a refinishing clear coat, or refinishing primer.

36. The process according to claim 19, wherein the substrate is an automotive body or parts thereof, a wall, a floor, an industrial structure, a ship's hulls or an aircraft body or parts thereof.

37. The process according to claim 19, wherein the coating has a smooth and uniform appearance.

38. A substrate coating according to the process to claim 19.
